(19) United States
(12) Patent Application Publication
(10) Pub. No.: US 2022/0284433 A1
(43) Pub. Date: Sep. 8, 2022

(54) UNIDIMENSIONAL EMBEDDING USING MULTI-MODAL DEEP LEARNING MODELS

(71) Applicant: Capital One Services, LLC, McLean, VA (US)

(72) Inventors: Minh LE, Bentonville, AR (US); Zachary KULIS, Arlington, VA (US); Tarek LAHLOU, Centreville, VA (US)

(73) Assignee: Capital One Services, LLC, McLean, VA (US)

(21) Appl. No.: 17/192,405

(22) Filed: Mar. 4, 2021

(51) Int. Cl. G06Q 20/40; G06F 17/18; G06N 3/08

(52) U.S. Cl. CPC G06Q 20/4016; G06F 17/18; G06N 3/084

(57) ABSTRACT

Unidimensional embedding using multi-modal deep learning models. An autoencoder executing on a processor may receive transaction data for a plurality of transactions, the transaction data including a plurality of fields, the plurality of fields including a plurality of different data types. An embeddings layer of the autoencoder may generate an embedding vector for a first transaction, the embedding vector includes floating point values to represent the plurality of data types of the transaction data. One or more fully connected layers of the autoencoder may generate, based on the embedding vector, a plurality of statistical distributions for the first transaction, each statistical distribution includes a respective embedding vector. A sampling layer of the autoencoder may sample a first statistical distribution of the plurality of statistical distributions. A decoder of the autoencoder may decode the first statistical distribution to generate an output representing the first transaction.

### TECHNICAL FIELD

Embodiments disclosed herein relate to computing models, such as neural networks. More specifically, embodiments disclosed herein relate to unidimensional embeddings using multi-modal deep learning models.

### BACKGROUND

Transactions are complex financial, business, and legal events. The data describing transactions is similarly complex. Conventional solutions have attempted to represent transaction data more efficiently. However, these solutions often fail to preserve the underlying data and any relationships in the data. Similarly, conventional solutions are susceptible to overfitting, which causes these solutions to lose representation integrity and generally leads to undesirable results.

### BRIEF SUMMARY

In a variety of embodiments, a computer-implemented method includes receiving, by an autoencoder executing on a processor, transaction data for a first transaction of a plurality of transactions, the transaction data including a plurality of fields, the plurality of fields including a plurality of data types, the plurality of data types including different data types, generating, by an embeddings layer of the autoencoder, an embedding vector for the first transaction, the embedding vector including floating point values to represent the plurality of data types, generating, by one or more fully connected layers of the autoencoder based on the embedding vector, a plurality of statistical distributions for the first transaction, each statistical distribution including a respective embedding vector, sampling, by a sampling layer of the autoencoder, a first statistical distribution of the plurality of statistical distributions, decoding, by a decoder of the autoencoder, the first statistical distribution to generate an output representing the first transaction, and storing the output in a storage medium. Other embodiments are described and claimed.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates a routine 500 in accordance with one embodiment.

FIG. 6 illustrates a routine 600 in accordance with one embodiment.

FIG. 7 illustrates a routine 700 in accordance with one embodiment.

FIG. 8 illustrates a computer architecture 800 in accordance with one embodiment.

### DETAILED DESCRIPTION

Embodiments disclosed herein provide techniques for unidimensional embedding s using multi-modal deep learning models to represent transaction data. For example, transaction data (e.g., credit card transaction data, debit card transaction data, etc.) may include different data types describing a given transaction (e.g., integers, alphanumeric text, Boolean values, etc.). Embodiments disclosed herein train an autoencoder to combine the different data types for a given transaction into a single vector of numbers while preserving semantic relationships between the different data elements. In some embodiments, multivariate distribution variational autoencoders may be used to represent information as statistical distributions.

In some embodiments, multi-stage prediction tasks may be used to ensure the output generated by an autoencoder maintains inter-component consistency. For example, single-label prediction tasks may be used on individual components of the transaction data. In addition and/or alternatively, multi-label prediction tasks may be performed on semantic sets of components. In addition and/or alternatively, time series prediction operations may be used to predict transactions at different times (e.g., to predict future transactions). In some embodiments, a negative sampling algorithm may be used for effective prediction learning. Further still, some embodiments may include measuring the effectiveness of a given embedding size.

Advantageously, embodiments disclosed herein combine data components of different types into a single vector of numbers while preserving semantic relationships between the data components. Furthermore, embodiments disclosed herein ensure representation integrity by avoiding overfitting. When an embedding is overfitted, new data may result in spurious embeddings. By using the techniques described herein, the overfitting and/or the spurious embeddings are reduced relative to conventional techniques. Further still, embodiments disclosed herein may advantageously determine an optimal size for embeddings. For example, larger embedding sizes may waste computational resources and increase the chance of spurious embeddings due to representation sparseness. Similarly, smaller embedding sizes lead to high probability of collisions in the embedding space. Advantageously, by identifying the optimal size for the embeddings, computing resources are not wasted, the amount of spurious embeddings are reduced, and/or the chance of collisions is reduced. Further still, by ensuring the predictability of the embeddings, embodiments disclosed herein generate embeddings that may be used in learning models to accurately predict future outcomes.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

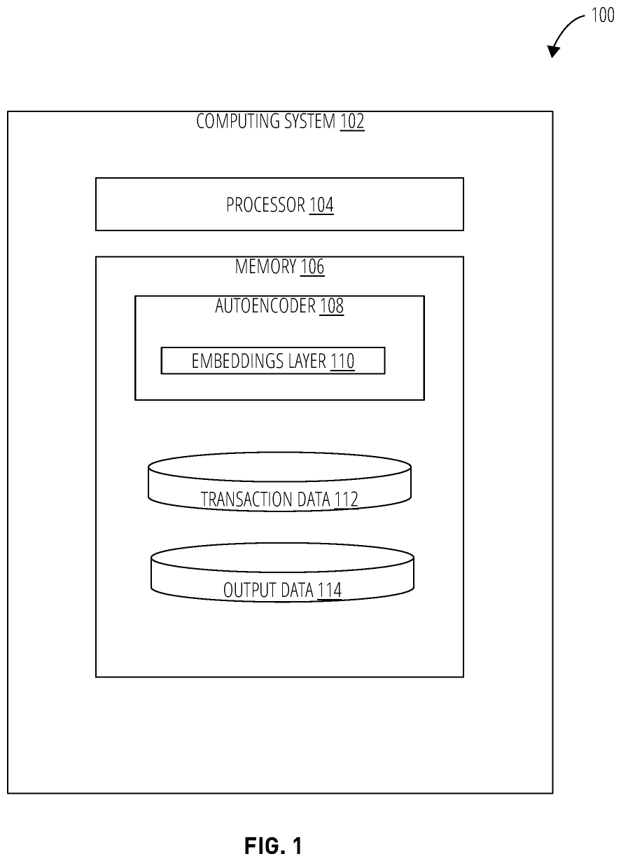

FIG. 1 depicts a schematic of an exemplary system 100, consistent with disclosed embodiments. As shown, the system 100 includes at least one computing system 102. The computing system 102 comprises at least a processor 104 a memory 106. As shown, the memory 106 includes an autoencoder 108, an embeddings layer 110 (also referred to as an “embeddings”), a transaction data 112, and an output data 114. The computing system 102 is representative of any type of computing system or device, such as a server, compute cluster, cloud computing environment, virtualized computing system, and the like.

The autoencoder 108 is representative of any type of autoencoder, including variational autoencoders, denoising autoencoders, sparse autoencoders, and contractive autoencoders. The use of a variational autoencoder as a reference example herein is not limiting of the disclosure. Generally, an autoencoder is a type of artificial neural network that learns in an unsupervised manner. For example, the values of the embeddings layer 110 may be learned during training of the autoencoder 108. Doing so trains the autoencoder 108 to convert different data types to a selected data type (e.g., a text string to a floating point number). The autoencoder 108 may be trained based on training data. The training data may include the transaction data 112 (and/or a portion thereof), which generally includes data describing a plurality of different transactions. The transaction data 112 may reflect any number and type of transactions, such as credit card transactions, debit card transactions, gift card transactions, and the like.

The transaction data 112 generally includes a plurality of different data elements, or fields, describing a given transaction. Stated differently, the transaction data 112 for a given transaction may include different data types, or data formats. For example, alphanumeric text strings may be used for customer and/or merchant names, integers may be used as unique identifiers for customers and/or merchants, floating point (or real number) values may be used for transaction amounts, and Boolean values may be used to reflect whether a virtual card number was used as payment for the transaction. As such, the dimensionality of the data space of the transaction data 112 is very high. Furthermore, some data elements in the transaction data 112 may have relationships, such as a relationship between different portions of an address (e.g., street address, city, state, and ZIP code). The autoencoder 108 may therefore be configured to reflect the different relationships between various elements of the transaction data 112. During training, the parameters in the layers of the autoencoder 108 are forced to represent the relationships. As such, the output data 114 generated by the autoencoder 108 may maintain the relationships in the transaction data 112. The output data 114 may include an embedding vector generated by the autoencoder 108 for a given transaction and/or a reconstruction of the input transaction data 112 for the transaction in the transaction data 112 based on the embedding vector generated by the autoencoder 108 for the transaction. In a variety of embodiments, the autoencoder 108 further computes a confidence metric or any other indicator of the probabilistic likelihood that the output data 114 is an accurate representation of the corresponding transaction data 112. For example, the confidence metric may be a value on a range from 0.0-1.0, where a value of 0.0 is indicative of the lowest confidence and a value of 1.0 is indicative of the highest confidence.

In some embodiments, negative sampling is implemented to generate negative training samples when training the autoencoder 108. The negative sampling may include determining which values for the negative samples materially differ from the actual data. For example, if an “amount” field for a transaction is $1,000, the negative sampling algorithm may determine a value (e.g., $5,000, $10,000, $100,000, etc.) to be substituted for the $1,000 amount field for the negative sample.

An embedding is an n-dimensional vector of floating point numerical values. In some embodiments, the embeddings include 100 dimensions. In such an embodiment, an embedding vector may include 100 floating point values. In such an example, the embeddings layer 110 layer of the autoencoder 108 may include 100 processing units (e.g., 100 neurons, one neuron for each dimension of the embeddings) with associated embedding (or weight) values. Embodiments are not limited in this context. In some embodiments, the embeddings layer 110 are initialized with initial values, which may be randomly assigned. In some examples, the training data selected from the transaction data 112 may be based on a larger dataset, such as a larger text embedding model that is compressed to a smaller dimension (e.g., compressing the BERT text embedding model to 100 dimensions).

As stated, the transaction data 112 may be highly-dimensional, while the embeddings 110 are a single vector of floating point numbers. Similarly, the transaction data 112 includes different data types, while the embeddings layer 110 include floating point numbers. As such, it is challenging to combine the different data types of the transaction data 112 into a single embedding vector 110. Advantageously, embodiments disclosed herein train the autoencoder 108 to learn the values for the embeddings layer 110 while maintaining the semantic relationships in the transaction data 112. Doing so allows the trained autoencoder 108 to generate accurate output data 114. For example, the trained autoencoder 108 may generate similar output data 114 (e.g., within a predefined distance in a data space of the output data 114) for similar transactions (e.g., transactions where the same payment card was used). Generally, the training of the autoencoder 108 may further include performing one or more backpropagation operations to refine the values of the autoencoder 108 (e.g., the embeddings layer 110). Generally, during backpropagation, the values of the embeddings layer 110 and/or the other components of the autoencoder 108 are refined based on the accuracy of the output data 114 generated by the autoencoder 108. Doing so may result in an embeddings layer 110 that most accurately maps the transaction data 112 to an embedding vector of floating point values.

Further still, the embeddings layer 110 may reflect enhanced address information. For example, address data represented by the embeddings layer 110 may include street address, city, state, zip code, and latitude and/or longitude of an entity (e.g., a customer and/or merchant). By providing the latitude and/or longitude (or other precise location information, such as global positioning system (GPS) information), the precise location information is preserved in the embeddings layer 110 along with the hierarchical street address, city, state, and zip code information. Doing so allows the embeddings layer 110 to be used in a variety of different machine learning applications.

For example, in some embodiments, the autoencoder 108 may be used to generate predictions as the output data 114, e.g., predicting future transactions for an account, predicting future transactions for different accounts, and the like. Similarly, the autoencoder 108 may generate other predictions, such as generating values for masked (e.g., hidden and/or removed) fields in the transaction data. For example, the autoencoder 108 may receive transaction data 112 where the amount field of a transaction is masked (e.g., such that the amount field is unspecified or otherwise unknown to the autoencoder 108). The autoencoder 108 may process the remaining transaction data 112 for the transaction to generate an output data 114 that includes a predicted value for the amount of the transaction. Similarly, a group of fields may be masked for a transaction in the transaction data 112, and the autoencoder 108 may generate an output that includes predicted values for the masked fields. In some embodiments, the training of the autoencoder 108 includes the generation of predictions, which are further used to refine the embeddings layer 110 via backpropagation. In addition and/or alternatively, the autoencoder 108 may generate predictions in one or more runtime operations (e.g., subsequent to the training of the autoencoder 108).

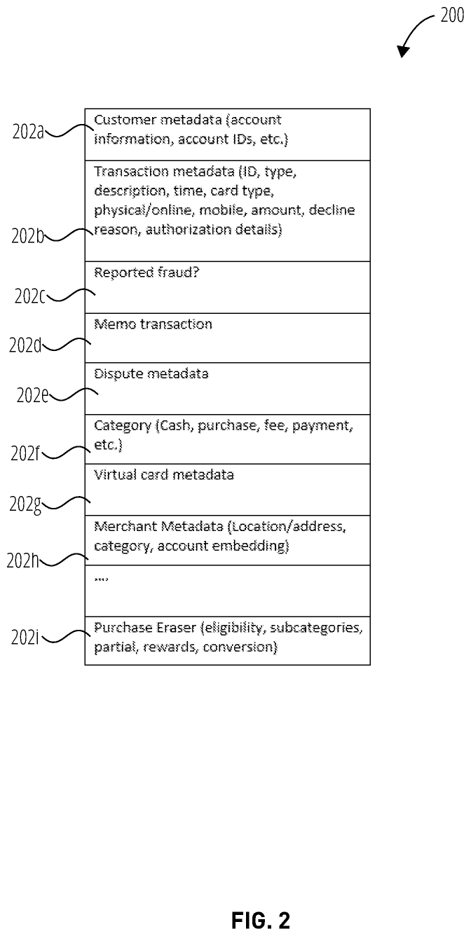

FIG. 2 illustrates an example table 200 representative of at least a portion of transaction data 112, consistent with disclosed embodiments. For example, as shown, the table 200 includes data elements, or fields, 202a-202i. Each element 202a-202i may be representative of one or more data elements in the transaction data 112. For example, the element 202a may include customer metadata, such as account information, name, address, account identifiers, and the like, for a customer involved in the transaction. The element 202b may include transaction metadata, such as a transaction identifier (ID), a description, time, card type, whether the transaction was physical or an online transaction, an amount of the transaction, and the like. The element 202c may reflect whether fraud analysis detected fraud for the transaction. The element 202d may include a memo (e.g., a description) of the transaction. The element 202e may reflect whether the transaction was disputed by the customer. The element 202f may specify a category of the transaction, while element 202g may include metadata describing a virtual card number (if a virtual card number was used to process payment for the transaction). The element 202h may include metadata describing the merchant involved in the transaction, such as address, location data (e.g., latitude/longitude, GPS coordinates, etc.), merchant category, an embedding 110 for the merchant, and the like. The element 202i may indicate whether the transaction used a “purchase eraser” feature, which may allow users to use points or other rewards to pay for the transaction. Therefore, as shown, the transaction data 112 includes a plurality of different data elements of a plurality of different data types (or data formats). Embodiments are not limited in these contexts.

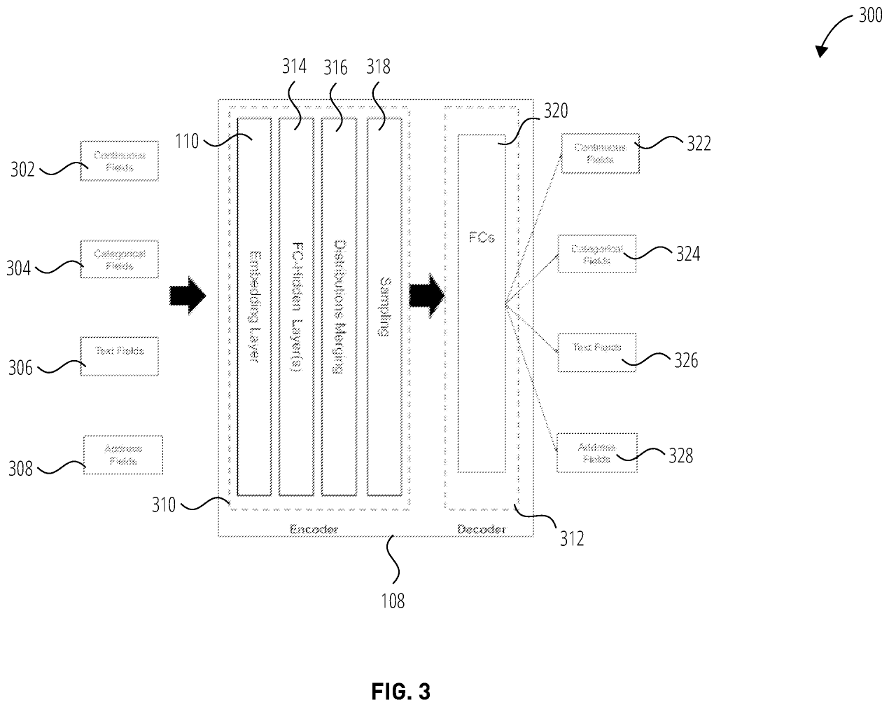

FIG. 3 is a schematic 300 illustrating the autoencoder 108 in greater detail, consistent with disclosed embodiments. As shown, the autoencoder 108 includes an encoder 310 and a decoder 312. The encoder 310 includes the embeddings layer 110, one or more fully connected hidden layers 314, a distribution merging layer 316, and a sampling layer 318. The decoder 312 may include one or more fully connected hidden layers 320.

As stated, the transaction data 112 may be used to train the autoencoder 108. In some embodiments, the transaction data 112 is divided into subsets for training (e.g., training the autoencoder 108 using 10% of the transaction data 112). As shown, the autoencoder 108 may receive transaction data 112 for one or more transactions as input. Illustratively, the transaction data 112 may include continuous fields 302, categorical fields 304, text fields 306, and address fields 308. The different fields 302-308 may include some or all of the data depicted in table 200 of FIG. 2. Embodiments are not limited in this context.

As shown, the embeddings layer 110 may receive the input data including fields 302-308. The neurons (not depicted) of the embeddings layer 110 may perform one or more processing operations on the input data to generate one or more floating point values representing the input data. For example, the embeddings layer 110 may generate a respective floating point value for the customer name, customer ID, merchant name, transaction amount, etc. The floating point values may be based at least in part on respective weight of each neuron of the embeddings layer 110. The fully connected hidden layers 314 may then combine the output of the embeddings layer 110, e.g., into a vector of floating point numbers. One or more distribution merging layers 316 may then generate a plurality of statistical distributions for the output of the fully connected hidden layers 314 (e.g., the combined floating point values). One or more sampling layers 318 may then sample, or select, one or more statistical distributions of the plurality of statistical distributions generated by the distribution merging layers 316. The statistical distribution sampled by the sampling layers 318 may therefore be the output of the encoder 310. The sampled statistical distribution may include an embedding vector representing the input transaction data 112. In some embodiments, each statistical distribution may include a respective mean value and a variance (and/or standard deviation) for each element of the embedding vector.

The decoder 312 may then receive the sampled distribution from the encoder 310. One or more fully connected hidden layers 320 of the decoder 312 may generate an output based on the sampled distribution. The output is illustratively shown as the continuous fields 322, categorical fields 324, text fields 326, and address fields 328, which may collectively correspond to an output data 114. Therefore, the decoder 312 converts the sampled distribution (e.g., an embedding vector of floating point values) to the original data formats of the transaction data 112 (e.g., names, addresses, precise location data, etc.). Over time, as the autoencoder 108 is trained, the output generated by the decoder 312 should correspond to (or approximate) the input to the encoder 310. The accuracy of the output, including the continuous fields 322, categorical fields 324, text fields 326, and address fields 328 relative to the input fields 302-308 may be used to refine the autoencoder 108 via one or more backpropagation operations. For example, the output may be compared to the input to determine the accuracy of the autoencoder 108. The training may be based on any number of training phases, or cycles. In some embodiments, the training continues using additional data elements from the transaction data 112 until an accuracy of the autoencoder 108 exceeds a threshold (or a loss of the autoencoder 108 is below a threshold).

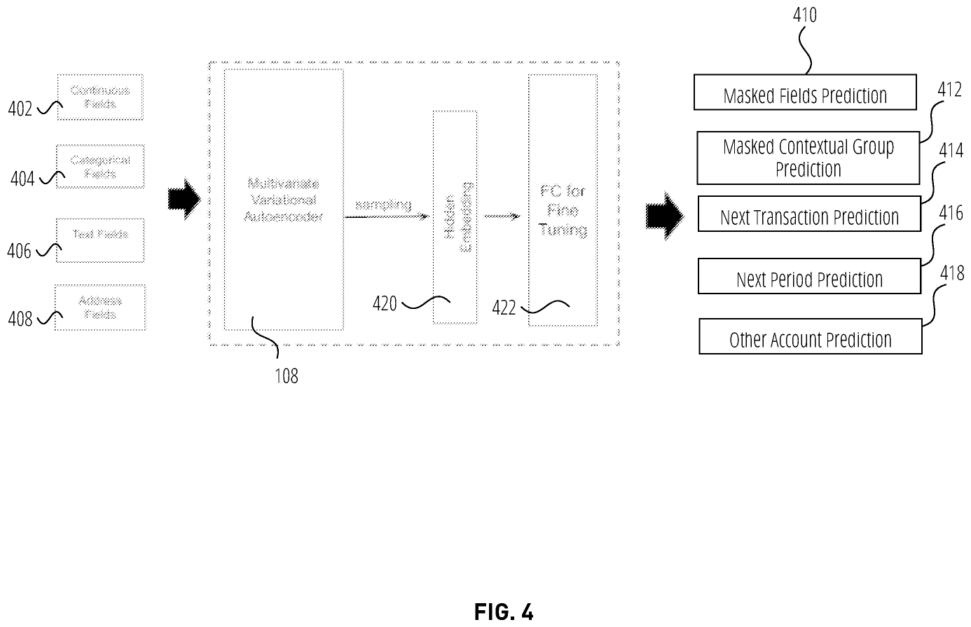

FIG. 4 is a schematic illustrating example prediction tasks that may be used to further train the autoencoder 108, consistent with disclosed embodiments. The example prediction tasks may be based on a subset of the transaction data 112 (e.g., 5% of the transaction data 112, 10% of the transaction data 112, etc.). As shown, the autoencoder 108 may receive transaction data 112 including continuous fields 402, categorical fields 404, text fields 406, and address fields 408. The autoencoder 108 may process the transaction data 112 as described above with reference to FIG. 3. The output of the autoencoder 108 in FIG. 4 may include a statistical distribution sampled by the sampling layers 318. The autoencoder 108 (or another component of the computing system 102) may mask one or more fields of the statistical distribution sampled by the sampling layers 318. Doing so may produce the hidden embeddings 420. For example, by masking the amount field of the sampled distribution, the amount field is removed from the hidden embeddings 420. One or more fully connected hidden layers 422 of the autoencoder 108 may then process the hidden embeddings 420 with the masked (or removed) values of one or more fields. Stated differently, the fully connected hidden layer 422 may process the sampled hidden embeddings 420 that do not include one or more data elements of the transaction data 112 (e.g., do specify an amount of the transaction, a customer account ID for the transaction, etc.). The fully connected hidden layers 422 may be a component of the decoder 312, e.g., the fully connected hidden layers 320. The output of the fully connected hidden layers 422 may include one or more predictions. The predictions generated by the autoencoder 108 may generally include a confidence metric or any other indicator of the probabilistic likelihood that the prediction is correct. For example, the confidence metric may be a value on a range from 0.0-1.0, where a value of 0.0 is indicative of the lowest confidence and a value of 1.0 is indicative of the highest confidence.

As shown, the predictions include masked fields predictions 410, masked contextual group predictions 412, next transaction predictions 414, next period predictions 416, and/or other account predictions 418. Generally, each prediction may include a predicted value for the one or more masked fields of the hidden embeddings 420. For example, if the amount field is removed from the hidden embeddings 420, the masked fields prediction 410 may include a predicted amount for the transaction. As stated, the autoencoder 108 may further include a confidence metric or score reflecting a confidence of the masked fields prediction 410. As the accuracy of the autoencoder 108 improves, the predicted amount should closely approximate the actual amount of the transaction. Similarly, as the accuracy improves, the computed confidence metric may also increase.

In a masked contextual group prediction 412, one or more related fields may be masked in the hidden embeddings 420. For example, the related masked fields may include street address information as well as precise location information (e.g., GPS coordinates) for customer and/or merchant of the transaction. Therefore, the output of the masked contextual group prediction 412 may include a predicted street address and the precise location (GPS coordinates) information for the customer and/or merchant of the transaction. As stated, the autoencoder 108 may further include a confidence metric or score reflecting a confidence of the masked contextual group prediction 412.

In a next transaction prediction 414, the autoencoder 108 may predict the next transaction for an account in the transaction data 112. For example, the hidden embeddings 420 may mask a field corresponding to the next transaction, where the next transaction is an element of the embedding vector sampled by the sampling layer 318. The next transaction prediction 414 may generally include a predicted transaction date, predicted merchant, predicted amount, an associated confidence metric, and any other metadata element for a transaction. For example, the next transaction prediction 414 may predict that the account holder will use their credit card to purchase groceries totaling $30 at example grocery merchant X on the following day, with an confidence metric of 0.7. As another example, if the hidden embeddings 420 indicate a customer recently purchased cereal, the next transaction prediction 414 may predict the customer will purchase milk with a confidence metric of 0.8. As stated, the next transaction prediction 414 may include additional information. In some embodiments, the next transaction prediction 414 is associated with a current time interval, e.g., a current day, week, month, year, etc.

In a next period prediction 416, the autoencoder 108 may predict the next transaction for an account in the transaction data 112, where the next transaction is for a future time interval (e.g., in 2 days, 2 weeks, 2 months, etc.). In some such embodiments, the next transaction element is masked to generate the hidden embeddings 420. The next period prediction 416 may generally include a predicted transaction date, predicted merchant, predicted amount, an associated confidence metric, and any other metadata describing a transaction. For example, the next period prediction 416 may predict that the account holder will use their credit card to by milk at the grocery store in one month.

In the other account prediction 418, the autoencoder 108 may predict the next transaction for a different account. In the other account predictions 418, the input to the autoencoder 108 is transaction data 112 for a transaction where a first account is the customer account, and the predicted transaction is for a second account, different than the first account. Stated differently, using the transaction data 112 for a transaction made by a first account, the autoencoder 108 may generate a predicted transaction for the second account. In some such embodiments, the next transaction element is masked to generate the hidden embeddings 420. The other account prediction 418 may generally include a predicted transaction date, predicted merchant, predicted amount, an associated confidence metric, and any other element of the transaction data 112. The other account prediction 418 will specify the second account as the customer account for the predicted transaction. For example, the other account prediction 418 may predict that the account holder of the second account will use their credit card to by milk at the grocery store, e.g., based on a similarity of the first and second accounts.

Regardless of the prediction type, the autoencoder 108 is further trained based on the predictions. For example, the values of the autoencoder 108 (e.g., the embeddings layer 110 and any other layer) may be refined via a backpropagation operation for each prediction. Advantageously, all predictions are based on some missing data (the hidden data elements). Over time, these predictions improve the accuracy of the autoencoder 108. Doing so allows the trained autoencoder 108 to perform similar and/or other predictions on new transaction data 112. For example, the transaction data 112 may be updated periodically, e.g., daily, weekly, monthly, etc. As the new transaction data 112 is received, the autoencoder 108 may use the new transaction data 112 to generate predictions such as the masked fields predictions 410, masked contextual group predictions 412, next transaction predictions 414, next period predictions 416, or other account predictions 418. As the accuracy of the autoencoder 108 improves, the confidence metrics of any associated predictions may also improve.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

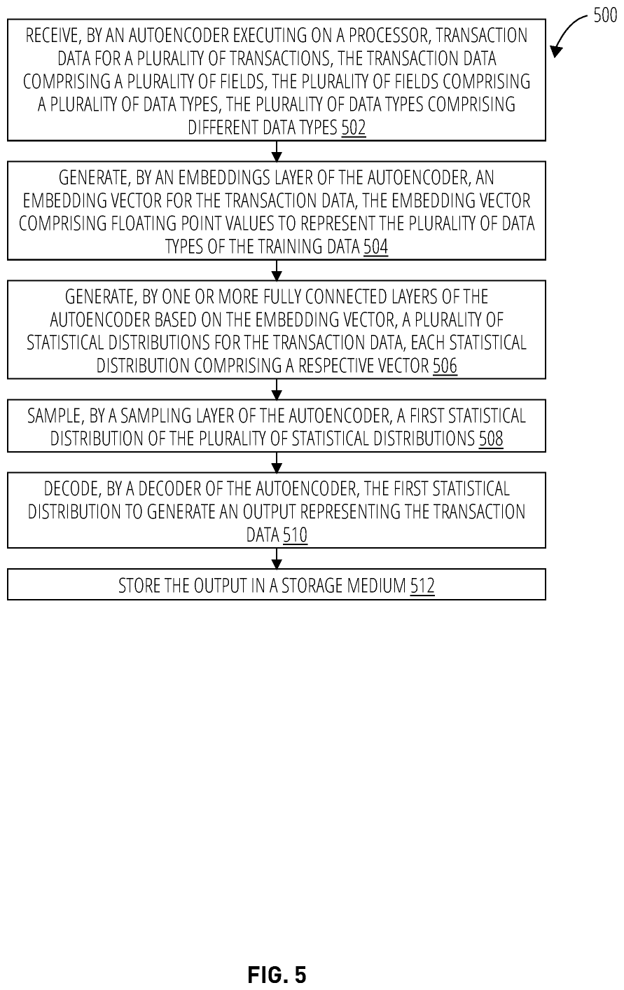

FIG. 5 illustrates an embodiment of a logic flow, or routine, 500. The logic flow 500 may be representative of some or all of the operations executed by one or more embodiments described herein. For example, the logic flow 500 may include some or all of the operations for unidimensional embeddings using multi-modal deep learning models. Embodiments are not limited in this context.

In block 502, routine 500 receives, by an autoencoder 108 executing on a processor, transaction data 112 for a first transaction of a plurality of transactions, the transaction data comprising a plurality of fields, the plurality of fields comprising a plurality of data types, the plurality of data types comprising different data types. In block 504, routine 500 generates, by an embeddings layer 110 of the autoencoder 108, an embedding vector for the transaction data, the embedding vector comprising floating point values to represent the plurality of data types. In block 506, routine 500 generates, by one or more fully connected layers of the autoencoder 108 based on the embedding vector, a plurality of statistical distributions for the first transaction, each statistical distribution comprising a respective embedding vector. In block 508, routine 500 samples, by a sampling layer of the autoencoder 108, a first statistical distribution of the plurality of statistical distributions. In block 510, routine 500 decodes, by a decoder 312 of the autoencoder 108, the embedding vector of the first statistical distribution to generate an output representing the first transaction. In block 512, routine 500 stores the output in a storage medium.

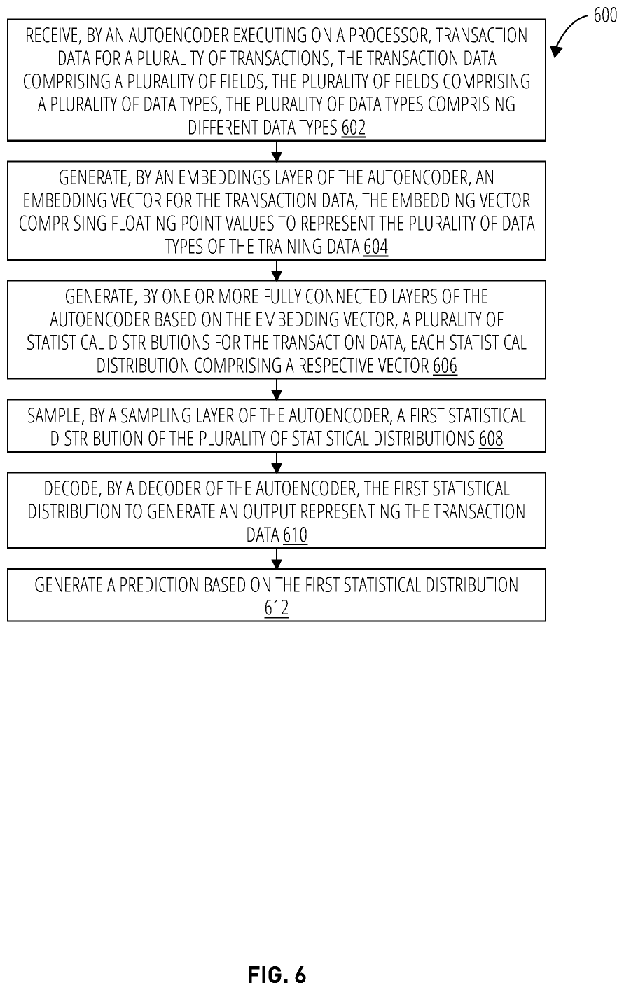

FIG. 6 illustrates an embodiment of a logic flow, or routine, 600. The logic flow 600 may be representative of some or all of the operations executed by one or more embodiments described herein. For example, the logic flow 600 may include some or all of the operations for unidimensional embeddings using multi-modal deep learning models. Embodiments are not limited in this context.

In block 602, routine 600 receives, by an autoencoder 108 executing on a processor, transaction data for a first transaction of a plurality of transactions, the transaction data comprising a plurality of fields, the plurality of fields comprising a plurality of data types, the plurality of data types comprising different data types. In block 604, routine 600 generates, by an embeddings layer 110 of the autoencoder 108, an embedding vector for the first transaction, the embedding vector comprising floating point values to represent the plurality of data types.

In block 606, routine 600 generates, by one or more fully connected layers of the autoencoder 108 based on the embedding vector, a plurality of statistical distributions for the first transaction, each statistical distribution comprising a respective vector. In block 608, routine 600 samples, by a sampling layer of the autoencoder 108, a first statistical distribution of the plurality of statistical distributions. In block 610, routine 600 decodes, by a decoder 312 of the autoencoder 108, the embedding vector of the first statistical distribution to generate an output representing the first transaction. In block 612, routine 600 generates a prediction based on the first statistical distribution. The prediction may be any type of prediction described herein.

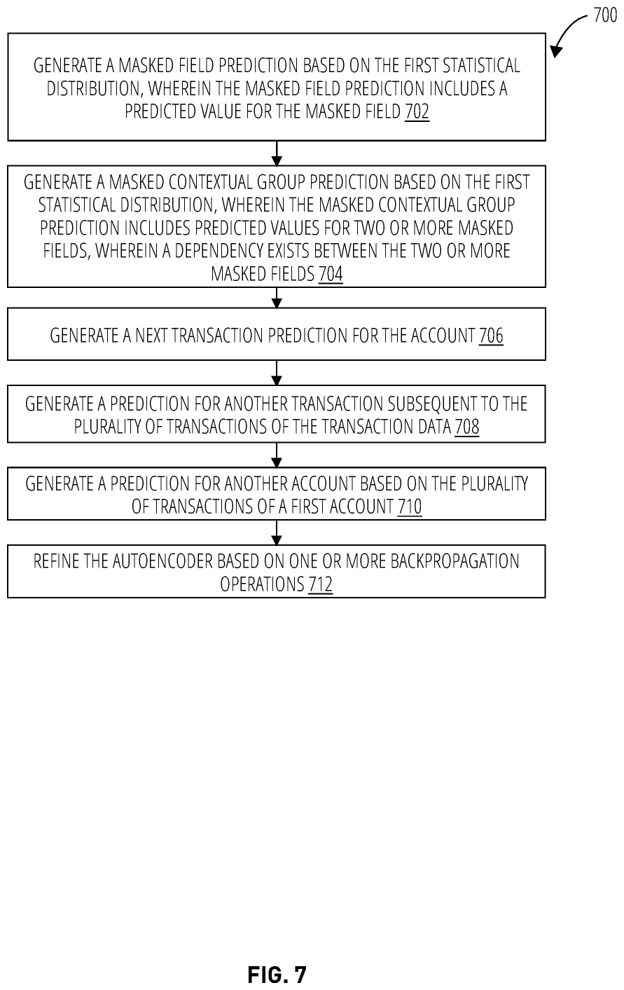

FIG. 7 illustrates an embodiment of a logic flow, or routine, 700. The logic flow 700 may be representative of some or all of the operations executed by one or more embodiments described herein. For example, the logic flow 700 may include some or all of the operations for generating predictions using an autoencoder 108. Embodiments are not limited in this context.

In block 702, the autoencoder 108 generates a masked field prediction 410 based on the first statistical distribution (e.g., the first statistical distribution, or embedding vector selected at block 608), wherein the masked field prediction 410 includes a predicted value for the masked field. In block 704, the autoencoder 108 generates a masked contextual group prediction 412 based on the embedding vector of the first statistical distribution, wherein the masked contextual group prediction includes predicted values for two or more masked fields, and wherein a dependency (or relationship) exists between the two or more masked fields.

In block 706, the autoencoder 108 generates a next transaction prediction 414 for the account based on the embedding vector of the first statistical distribution. In block 708, the autoencoder 108 generates a next period prediction 416 for another transaction based on the embedding vector of the first statistical distribution. The another transaction may be for a time interval that is subsequent to a current time interval. In block 710, the autoencoder 108 generates an other account prediction 418 for another account based on a sampled embedding vector for a first account (e.g., the sampled first statistical distribution, which is for a first account.

In block 712, the values of the autoencoder 108 may be refined based on one or more backpropagation operations, e.g., a backpropagation operation after each prediction. However, in some embodiments, the predictions at blocks 702-710 are runtime predictions (e.g., using a trained autoencoder 108), and the backpropagation is not performed. Therefore, block 712 may be optional.

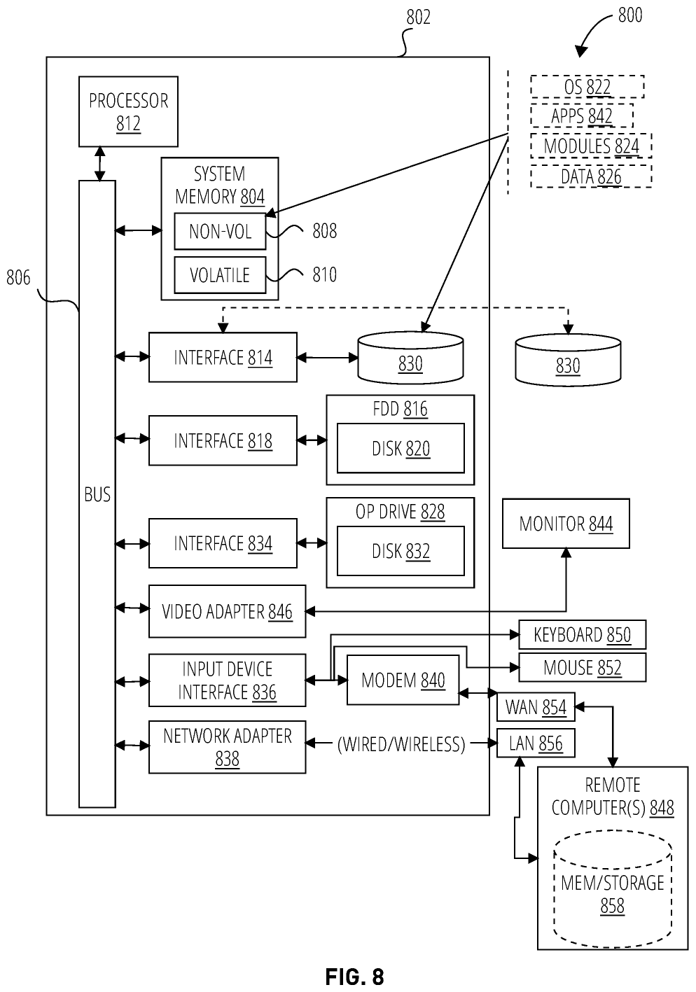

FIG. 8 illustrates an embodiment of an exemplary computer architecture 800 suitable for implementing various embodiments as previously described. In a variety of embodiments, the computer architecture 800 may include or be implemented as part of the system 100.

As used in this application, the terms “system” and “component” are intended to refer to a computer-related entity, either hardware, a combination of hardware and software, software, or software in execution, examples of which are provided by the exemplary computing computer architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 100.

As shown in FIG. 8, the computing architecture 100 includes a processor 812, a system memory 804 and a system bus 806. The processor 812 can be any of various commercially available processors.

The system bus 806 provides an interface for system components including, but not limited to, the system memory 804 to the processor 812. The system bus 806 can be any of several types of bus structure that may further interconnect to a memory bus (with or without a memory controller), a peripheral bus, and a local bus using any of a variety of commercially available bus architectures. Interface adapters may connect to the system bus 808 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 100 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 804 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 804 can include non-volatile 808 and/or volatile 810. A basic input/output system (BIOS) can be stored in the non-volatile 808.

The computer 802 may include various types of computer-readable storage media in the form of one or more lower speed memory units, including an internal (or external) hard disk drive 830, a magnetic disk drive 816 to read from or write to a removable magnetic disk 820, and an optical disk drive 828 to read from or write to a removable optical disk 832 (e.g., a CD-ROM or DVD). The hard disk drive 830, magnetic disk drive 816 and optical disk drive 828 can be connected to system bus 806 the by an HDD interface 814, and FDD interface 818 and an optical disk drive interface 834, respectively. The HDD interface 814 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 808, and volatile 810, including an operating system 822, one or more applications 842, other program modules 824, and program data 826. In a variety of embodiments, the one or more applications 842, other program modules 824, and program data 826 can include, for example, the various applications and/or components of the computing system 102.

A user can enter commands and information into the computer 802 through one or more wire/wireless input devices, for example, a keyboard 850 and a pointing device, such as a mouse 852. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 812 through an input device interface 836 that is coupled to the system bus 806 but can be connected by other interfaces such as a parallel port, IEEE 1394 serial port, a game port, a USB port, an IR interface, and so forth.

A monitor 844 or other type of display device is also connected to the system bus 806 via an interface, such as a video adapter 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all the elements described relative to the computer 802, although, for purposes of brevity, only a memory and/or storage device 858 is illustrated. The logical connections depicted include wire/wireless connectivity to a local area network 856 and/or larger networks, for example, a wide area network 854. Such LAN and WAN networking environments are commonplace in offices and companies, and facilitate enterprise-wide computer networks, such as intranets, all of which may connect to a global communications network, for example, the Internet.

When used in a local area network 856 networking environment, the computer 802 is connected to the local area network 856 through a wire and/or wireless communication network interface or network adapter 838. The network adapter 838 can facilitate wire and/or wireless communications to the local area network 856, which may also include a wireless access point disposed thereon for communicating with the wireless functionality of the network adapter 838.

When used in a wide area network 854 networking environment, the computer 802 can include a modem 840, or is connected to a communications server on the wide area network 854 or has other means for establishing communications over the wide area network 854, such as by way of the Internet. The modem 840, which can be internal or external and a wire and/or wireless device, connects to the system bus 806 via the input device interface 836. In a networked environment, program modules depicted relative to the computer 802, or portions thereof, can be stored in the remote memory and/or storage device 858. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.118 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1-8 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method, comprising:
receiving, by an autoencoder executing on a processor, transaction data for a plurality of transactions, the transaction data comprising a plurality of fields, the plurality of fields comprising a plurality of data types, the plurality of data types comprising different data types;
generating, by an embeddings layer of the autoencoder, an embedding vector for a first transaction of the plurality of transactions, the embedding vector comprising floating point values to represent the plurality of data types;
generating, by one or more fully connected layers of the autoencoder based on the embedding vector, a plurality of statistical distributions for the first transaction, each statistical distribution comprising a respective embedding vector;
sampling, by a sampling layer of the autoencoder, a first statistical distribution of the plurality of statistical distributions;
decoding, by a decoder of the autoencoder, the first statistical distribution to generate an output representing the first transaction; and
storing the output in a storage medium.

2. The computer-implemented method of claim 1, further comprising:
masking, by the processor, a value for a first element of the first statistical distribution; and
generating, by the fully connected layers of the autoencoder based on the first statistical distribution including the masked value for the first element, an output vector for another transaction, the output vector including a value for the first element, the another transaction not included in the plurality of transactions of the transaction data.

3. The computer-implemented method of claim 1, further comprising:
masking, by the processor, a value for a first element of the first statistical distribution; and
generating, by the fully connected layers of the autoencoder based on the first statistical distribution including the masked value for the first element, an output comprising a value for the first element.

4. The computer-implemented method of claim 1, wherein a first field of the plurality of fields is dependent on a second field of the plurality of fields, wherein the embedding vector and the plurality of statistical distributions reflect the dependency of the first field on the second field.

5. The computer-implemented method of claim 4, further comprising:
masking, by the processor, a value for a first element of the first statistical distribution and a value for a second element of the first statistical distribution, wherein the first element and the second element of the first statistical distribution correspond to the first field and the second field, respectively; and
generating, by the fully connected layers of the autoencoder based on the first statistical distribution including the masked values for the first and second elements, an output comprising a respective value for the first element and second elements.

6. The computer-implemented method of claim 1, further comprising:
generating, by the fully connected layers of the autoencoder based on the first statistical distribution, an output vector for another transaction, the another transaction subsequent to the plurality of transactions of the transaction data.

7. The computer-implemented method of claim 1, wherein first statistical distribution is associated with a first account of a plurality of accounts, the method further comprising:
generating, by the fully connected layers of the autoencoder based on the first statistical distribution, an output vector for another transaction associated with a second account of the plurality of accounts.

8. A non-transitory computer-readable storage medium, the computer-readable storage medium including instructions that when executed by a processor, cause the processor to:
receive, by an autoencoder, transaction data for a plurality of transactions, the transaction data comprising a plurality of fields, the plurality of fields comprising a plurality of data types, the plurality of data types comprising different data types;
generate, by an embeddings layer of the autoencoder, an embedding vector for a first transaction of the plurality of transactions, the embedding vector comprising floating point values to represent the plurality of data types;
generate, by one or more fully connected layers of the autoencoder based on the embedding vector, a plurality of statistical distributions for the first transaction, each statistical distribution comprising a respective embedding vector;
sample, by a sampling layer of the autoencoder, a first statistical distribution of the plurality of statistical distributions;
decode, by a decoder of the autoencoder, the first statistical distribution to generate an output representing the first transaction; and
store the output in a storage medium.

9. The computer-readable storage medium of claim 8, wherein the instructions further configure the processor to:
mask a value for a first element of the first statistical distribution; and
generate, by the fully connected layers of the autoencoder based on the first statistical distribution including the masked value for the first element, an output vector for another transaction, the output vector including a value for the first element, the another transaction not included in the plurality of transactions of the transaction data.

10. The computer-readable storage medium of claim 8, wherein the instructions further configure the processor to:
mask a first element of the first statistical distribution; and
generate, by the fully connected layers of the autoencoder based on the first statistical distribution including the masked value for the first element, an output comprising a value for the first element.

11. The computer-readable storage medium of claim 8, wherein a first field of the plurality of fields is dependent on a second field of the plurality of fields, wherein the embedding vector and the plurality of statistical distributions reflect the dependency of the first field on the second field.

12. The computer-readable storage medium of claim 11, wherein the instructions further configure the processor to:
mask a value for a first element of the first statistical distribution and a value for a second element of the first statistical distribution, wherein the first element and the second element of the first statistical distribution correspond to the first field and the second field, respectively; and
generate, by the fully connected layers of the autoencoder based on the first statistical distribution including the masked values of the first and second elements, an output comprising a respective value for the first element and second elements.

13. The computer-readable storage medium of claim 8, wherein the instructions further configure the processor to:
generate, by the fully connected layers of the autoencoder based on the first statistical distribution, an output vector for another transaction, the another transaction subsequent to the plurality of transactions of the transaction data.

14. The computer-readable storage medium of claim 8, wherein the first statistical distribution is associated with a first account of a plurality of accounts, wherein the instructions further configure the processor to:
generate, by the fully connected layers of the autoencoder based on the first statistical distribution, an output vector for another transaction associated with a second account of the plurality of accounts.

15. A computing apparatus comprising:
a processor; and
a memory storing instructions that, when executed by the processor, configure the processor to:
receive, by an autoencoder executing on the processor, transaction data for a plurality of transactions, the transaction data comprising a plurality of fields, the plurality of fields comprising a plurality of data types, the plurality of data types comprising different data types;
generate, by an embeddings layer of the autoencoder, an embedding vector for a first transaction of the plurality of transactions, the embedding vector comprising floating point values to represent the plurality of data types;
generate, by one or more fully connected layers of the autoencoder based on the embedding vector, a plurality of statistical distributions for the first transaction, each statistical distribution comprising a respective embedding vector;
sample, by a sampling layer of the autoencoder, a first statistical distribution of the plurality of statistical distributions;
decode, by a decoder of the autoencoder, the first statistical distribution to generate an output representing the first transaction; and
store the output in a storage medium.

16. The computing apparatus of claim 15, wherein the instructions further configure the apparatus to:
mask a value for a first element of the first statistical distribution; and
generate, by the fully connected layers of the autoencoder based on the first statistical distribution including the masked value for the first element, an output vector for another transaction, the output vector including a value for the first element, the another transaction not included in the plurality of transactions of the transaction data.

17. The computing apparatus of claim 15, wherein the instructions further configure the processor to:
mask a value for a first element of the first statistical distribution; and
generate, by the fully connected layers of the autoencoder based on the first statistical distribution including the masked value for the first element, an output comprising a value for the first element.

18. The computing apparatus of claim 15, wherein a first field of the plurality of fields is dependent on a second field of the plurality of fields, wherein the embedding vector and the plurality of statistical distributions reflect the dependency of the first field on the second field, wherein the instructions further configure the processor to:
mask a value for a first element of the first statistical distribution and a value for second element of the first statistical distribution, wherein the first element and the second element of the first statistical distribution correspond to the first field and the second field, respectively; and
generate, by the fully connected layers of the autoencoder based on the first statistical distribution including the masked values for the first and second elements, an output comprising a respective value for the first element and second elements.

19. The computing apparatus of claim 15, wherein the instructions further configure the apparatus to:
generate, by the fully connected layers of the autoencoder based on the first statistical distribution, an output vector for another transaction, the another transaction subsequent to the plurality of transactions of the transaction data.

20. The computing apparatus of claim 15, wherein the first statistical distribution is associated with a first account of a plurality of accounts, wherein the instructions further configure the apparatus to:
generate, by the fully connected layers of the autoencoder based on the first statistical distribution, an output vector for another transaction associated with a second account of the plurality of accounts.
